(19) United States
(12) Patent Application Publication
(10) Pub. No.: US 2008/0211671 A1
(43) Pub. Date: Sep. 4, 2008

(54) SMART RFID CHECKOUT KIOSK

(75) Inventor: Michael A. Daily, Claremont, NC (US)

Correspondence Address: SNELL & WILMER LLP (OC), 600 ANTON BOULEVARD, SUITE 1400, COSTA MESA, CA, 92626, US

(73) Assignee: DAGOSI, LLC, Hickory, NC (US)

(21) Appl. No.: 12/013,255

(22) Filed: Jan. 11, 2008

Related U.S. Application Data
(60) Provisional application No. 60/879,966, filed on Jan. 11, 2007.

(51) Int. Cl. G08B 13/14

(52) U.S. Cl. 340/572.1

(57) ABSTRACT

The invention relates to a self-checkout kiosk that utilizes RFID tags and a distance and direction RFID reader to detect sales merchandise. The kiosk includes POS software, which automatically detects items selected by a patron that have previously been received into inventory and tagged, which facilitates the completion of the sale by detecting the distance and direction of the RFID tag. The kiosk incorporates a communication system and means for the patron to communicate with a store employee located distant from the kiosk. The POS software utilizes multiple payment methods and has the capability to display advertisements based on product being detected.

### CLAIM OF PRIORITY UNDER 35 U.S.C. §119

The present application for patent claims priority to Provisional Application No. 60/879,966 entitled “SMART RFID CHECKOUT KIOSK,” filed Jan. 11, 2007, and assigned to the assignee hereof and hereby expressly incorporated by reference herein.

### BACKGROUND

1. Field

The invention relates to a self-checkout kiosk having a security system. More particularly, the invention relates to a self-checkout kiosk that utilizes radio frequency identification (RFID) tags on sales merchandise and a RFID reader to detect the distance and direction of the RFID tags and to initiate an alarm.

2. Background

Checkout kiosks are well known in the art. One example of such a checkout kiosk may be found in grocery stores having self-checkout lanes. For example, a patron may place individual items next to a bar code reader so the bar code reader can scan and identify the particular item. Typically, an employee of the grocery store is present to supervise the self-checkout lanes by providing assistance to the patrons if needed and security to prevent theft of the items. Such a checkout kiosk has many obvious limitations including the need for an employee to always be present to provide assistance and security. The present invention provides a novel solution to avoid these limitations.

Therefore, a need exists in the art for techniques to provide assistance and security without an employee always being present to provide assistance and security.

### SUMMARY

A self-checkout apparatus for detecting an RFID tag may include a housing having an acrylic panel, a memory module positioned in the housing for storing POS software, a processor for executing the POS software, an antenna positioned in the housing for transmitting a TX signal through the acrylic panel of the housing to an RFID tag and for receiving a RX signal from the RFID tag, and an RFID reader, positioned in the housing and controlled by the POS software, for determining an item number for the RFID tag using the RX signal. The self-checkout apparatus may also include a security module positioned in a different location than the housing, the security module having an acrylic panel, an antenna positioned in the security module for transmitting a TX signal through the acrylic panel of the security module to the RFID tag and for receiving a RX signal from the RFID tag, and a distance and direction RFID reader positioned in the security module to receive the RX signal from the RFID tag, determine a distance and a direction of movement of the RFID tag, determine whether the distance is greater than a predetermined value (e.g., 3 feet) and the direction of movement is in a predetermined direction (e.g., exiting the store), and if so, transmit a security signal and a description of an item with the RFID tag to the processor.

A method for detecting whether an item has been paid for or stolen using an RFID tag may include transmitting a first signal to an RFID tag, receiving a second signal from the RFID tag, determining a distance and a direction of movement of the RFID tag using the second signal, determining whether the distance is greater than a predetermined value, determining whether the direction of movement is in a predetermined direction, and transmitting an alarm signal when the distance is greater than the predetermined value and the direction of movement is in the predetermined direction.

### BRIEF DESCRIPTION OF THE DRAWINGS

The features, objects, and advantages of the invention will become more apparent from the detailed description set forth below when taken in conjunction with the drawings, wherein:

FIG. 1 is a block diagram of a self-checkout kiosk system for locating and detecting the distance and direction of an RFID tag according to an embodiment of the invention;

FIG. 2 is a front perspective view of the self-checkout kiosk of FIG. 1 according to an embodiment of the invention;

FIG. 3 is a front perspective view of the security module and gate module of FIG. 1 according to an embodiment of the invention;

FIG. 4 is a rear perspective view of the security module and gate module of FIG. 1 according to an embodiment of the invention; and

FIG. 5 is a flow chart of a method for detecting whether an item has been paid for or stolen using an RFID tag according to an embodiment of the invention.

### DETAILED DESCRIPTION

Apparatus, systems and methods that implement the embodiments of the various features of the invention will now be described with reference to the drawings. The drawings and the associated descriptions are provided to illustrate some embodiments of the invention and not to limit the scope of the invention. Throughout the drawings, reference numbers are re-used to indicate correspondence between referenced elements. In addition, the first digit of each reference number indicates the figure in which the element first appears.

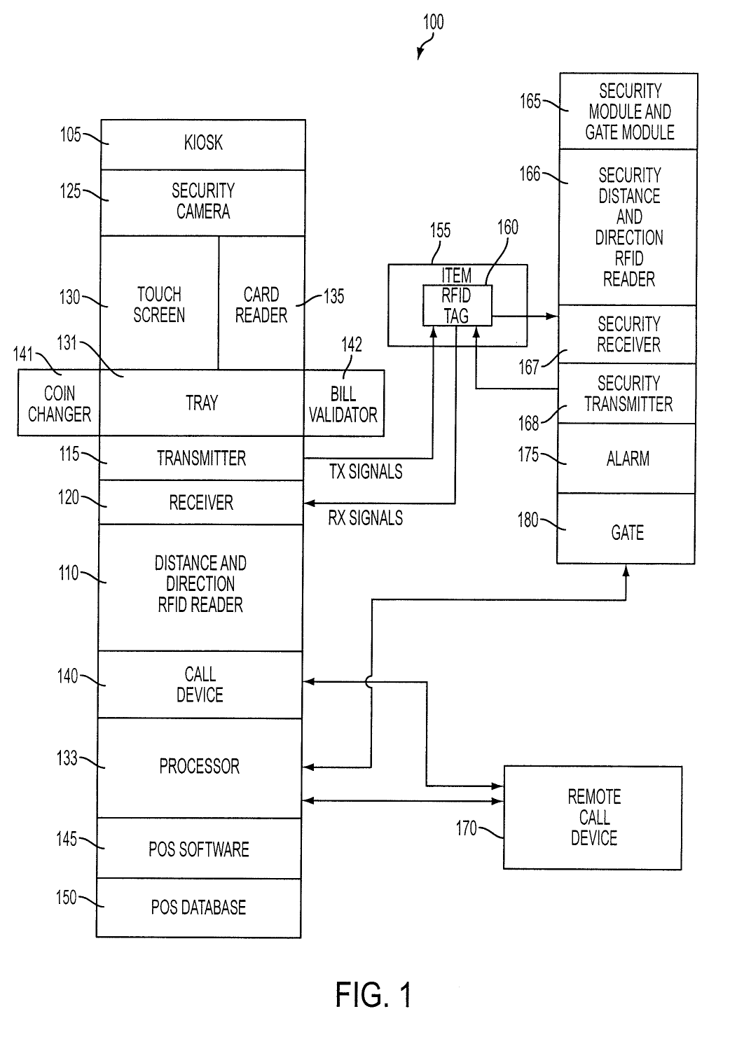

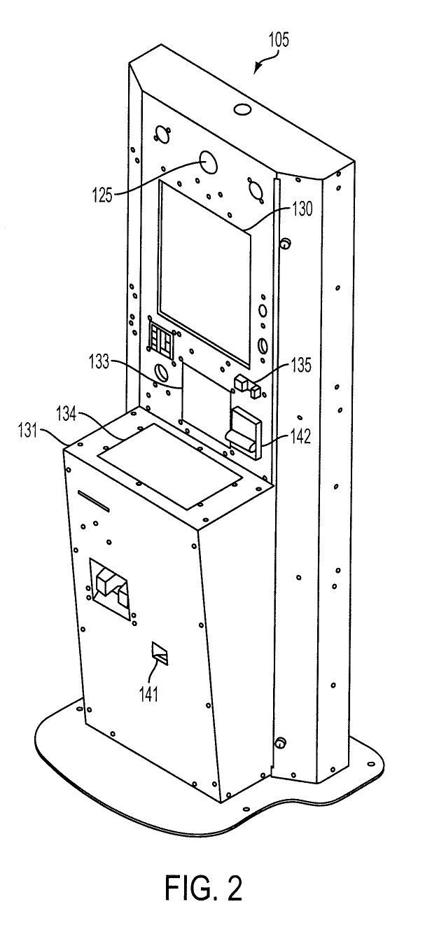

FIG. 1 is a block diagram of a self-checkout kiosk system 100 for locating and detecting the distance and direction of an RFID tag according to an embodiment of the invention. The system 100 can also detect when a patron fails to pay for an item 155 and sound an alarm 175 indicating that the item 155 has not been paid for. The system 100 may include a kiosk or point-of-sale (POS) device 105, a distance and direction RFID reader 110, a security camera 125, a touch screen 130, a processor 133, a card reader 135, a call device 140, POS software 145, POS database 150, an RFID tag 160, a security module and gate module 165, a security distance and direction RFID reader 166, a remote call device 170, an alarm 175, and a gate 180. Some advantages of the system 100 include increased speed of transactions, better quality of service and overall patron satisfaction with the selling process without the need for checkout personnel to be located at the immediate location of the kiosk 105, and the security distance and direction RFID reader 166 for determining whether the item 155 has been paid for and if not, sounding the alarm 175 and recording a description (e.g., item name, number or description) of the item 155 that was stolen for inventory management.

The system 100 may be used to illustrate the apparatus and methods described herein for locating and detecting the distance and direction of the RFID tag 160 and determining whether any items have been stolen. The system 100 and the components of the system 100 may be implemented using hardware, software, firmware, middleware, microcode, or any combination thereof. One or more components can be rearranged and/or combined, and other systems can be used in place of the system 100 while still maintaining the spirit and scope of the invention. Additional components may be added to the system 100 or may be removed from the system 100 while still maintaining the spirit and scope of the invention. The components of the system 100 may be connected to each other using wireless and/or wired connections.

The kiosk or point-of-sale device 105 is a device that allows a patron to use the touch screen 130 to purchase items 155 detected by the distance and direction RFID reader 110. The kiosk 105 may be a housing having a cavity that holds the electronic components. The kiosk 105 may have a shelf or tray 131 that is used by patrons as a convenient location to place items 155 for checkout. The kiosk 105 may be an armature made of a material that allows passage of RF signals. In one embodiment, the kiosk 105 is made out of a metallic material (e.g., steel) with first and second non-metallic (e.g., acrylic) panels or plates 133 and 134 to allow the passage of RF signals at a frequency of about 915 MHz. In one embodiment, first transmitter 115a and first receiver 120a are positioned behind the first acrylic panel 133 and second transmitter 115b and second receiver 120b are positioned under the second acrylic panel 134. A person skilled in the art will appreciate that the kiosk 105 may be constructed of various materials including plastic and fiberglass which also allow the passage of RF signals of desired frequencies. One advantage of the kiosk 105 is its overall small footprint size. The kiosk 105 and the security module and gate module 165 are small enough to use in a confined area.

The distance and direction RFID reader 110 detects and identifies each RFID tag 160 within a predetermined range. The distance and direction RFID readers 110, 166 can detect the distance to the RFID tags 160 and the direction and speed of movement of the RFID tags 160. Some examples of the distance and direction RFID readers 110, 166 are described in U.S. Pat. Nos. 6,868,073 and 6,975,229 and U.S. Patent Application Publication Nos. 20060022825 and 20050237953. In one embodiment, the distance and direction RFID readers 110 may include a transmitter 115 with one or more RFID antennas and a receiver 120 with one or more RFID antennas. In one embodiment, the distance and direction RFID reader 166 may include a transmitter 167 with one or more RFID antennas and a receiver 168 with one or more RFID antennas. The distance and direction RFID reader 110 may be used to scan in the item 155 for purchase by the patron and the distance and direction RFID reader 166 may be used to detect whether the item 155 has been stolen (e.g., travels beyond the security module and gate module 165 by a certain distance towards a certain direction—outside the store at a certain speed) and if so, identify by item names or numbers the specific items 155 that were stolen.

The POS software 145 controls the operations and functions of the distance and direction RFID readers 110, 166. The POS software 145 can detect the presence of the RFID tag 160, determine whether the RFID tag 160 is approaching or moving away from the kiosk 105, determine whether the RFID tag 160 is moving towards an exit, determine whether the RFID tag 160 has moved a certain distance in a certain direction from the exit, and identify and list the stolen items 155. If the POS software 145 determines that the RFID tags 160 are approaching the kiosk 105 (e.g., within about 3 feet of the RFID antennas), the touch screen 130 displays a list of items 155 in the patron's possession (e.g., in the basket or cart) and allows the patron to perform a self-checkout using the card reader 135. If the POS software 145 determines that the RFID tags 160 are moving towards the exit (e.g., within about 2 feet of the exit), the POS software 145 send an alarm signal to the security module 165 to sound an alarm 175 and a theft signal to the POS database 150 to record the event as a theft. If the POS software 145 determines that the RFID tags 160 are not moving or are beyond a predetermined distance (e.g., greater than about 3 feet) from the kiosk 105, the POS software 145 continues to monitor the RFID tags 160 to determine whether the RFID tags 160 are ready for self-checkout or are considered under a theft status. The POS software 145 may be used with the transmitters 115, 167 and the receivers 120, 168 to calculate distance and relative direction of the RFID tags 160.

The POS database 150 may include two databases. The first database may be a Microsoft SQL Server Database that contains the entire local inventory of tagged items 155 or products. The second database may be a Microsoft SQL Server Database that contains all transactions completed at the kiosk 105 and a list of all stolen items 155. The second database can be remotely accessed by employees or managers to conduct inventory management. Both databases are synchronized by a separate program that monitors the operation of the kiosk 105 and the security module and gate module 165. The POS software 145 allows for multiple payment methods that can be turned on or off.

During operation, the transmitter 115 transmits TX signals in an area near the patrons whom are ready to checkout. Each TX signal may be amplitude, phase, and/or frequency shifted from another TX signal. Each item 155 has an RFID tag 160 affixed to it. The RFID tags 160 may receive the TX signals and transmit RX signals to the receiver 120. Each RX signal may be amplitude, phase, and/or frequency shifted from another RX signal. A unique 24 hex digit identifier is exchanged between the TX and RX signals. Energy from the TX signal activates the RFID tag 160 RX signal and returns a 24 hex digit identifier to the receiver 120. Based on the amplitude, phase, and/or frequency differences between the RX signals received by the receiver 120, the distance and direction RFID reader 110 determines the distance of the RFID tags 160 from the kiosk 105, the relative direction of the RFID tags 160, and the position of the RFID tags 160 by comparing the I-Q phase angle vectors of the RX signals. Simple trigonometry and use of vector mathematics can calculate the distance and direction of the RFID tag 160.

In one embodiment, the distance and direction RFID reader 110 may include two circularly polarized 915 MHz antennas both mounted in the same or similar direction. In one embodiment, the first antenna may be mounted behind the first acrylic panel 133 of the kiosk 105. The second antenna may be mounted adjacent and perpendicular to the first antenna such as under the second acrylic panel 134. The two antennas create strong tag detection coverage by emitting a 45 degree radiation pattern from each antenna which serves the dual purpose of detecting tagged products to complete sales and detecting tagged products to detect theft. Still another advantage of the invention results from a component which contains an antenna mounted facing upward in the tray 131 to facilitate detection of the RFID tag 160.

The item number, name, price, and discount amount for each item 155 is stored in the POS database 150. The touch screen 130, which is controlled by the processor 133, allows an employee to input or scan the details of each item 155 into the POS database 150. In addition, the touch screen 130 may be used to view all the purchased items 155, price of each item 155, and any discount applied to an item 155. An advantageous feature is an electronic advertisement display generated by the POS software 145 that allows advertising above the POS self-checkout features on the same 19″ LCD touch screen display. The processor 133 may be a computer and the touch screen 130 may be an inverted 19″ SVGA LCD touch screen.

The processor 133 may be a standard PC with sufficient 10 ports to accommodate the ancillary electronic connections and a 19″ LCD touch screen 130 that can be rotated about 90 degrees. The processor 133 and the touch screen 130 are the main interfaces between the kiosk 105 and the patron. The processor 133 runs the POS software 145. The processor 133 may utilize software written in Visual Basic version 6.0 which is compiled to create the POS software 145 that interfaces with the distance and direction RFID reader 110. The POS software 145 also allows programming of the RFID tags 160 and stocking of the shelves with the kiosk 105 without the need for additional software. The processor 133 may store computer instructions on a machine readable medium for controlling the operations and functions of the various components of the kiosk 105. The processor 133 may include one or more memory modules for storing instructions to control the operations and functions of the various components of the kiosk 105. The term “machine readable medium” includes, but is not limited to, random access memory (RAM), flash memory, read-only memory (ROM), EPROM, EEPROM, registers, hard disk, removable disk, CD-ROM, DVD, wireless channels, and various other mediums capable of storing, containing or carrying instruction(s) and/or data. The processor 133 may be an Advanced RISC Machine (ARM), a controller, a digital signal processor (DSP), a microprocessor, or any other device capable of processing instructions.

The kiosk 105 allows a patron to purchase items 155 that have been tagged with an RFID tag 160 and stored in the POS database 150. In one embodiment, a patron may approach the kiosk 105, which automatically detects and identifies each item 155 of the patron's using the distance and direction RFID reader 110, and conducts a self-checkout process where the patron pays for the items 155 using the card reader 135 (e.g., a credit card reader) or other means known in the art. The POS software 145 consummates the sale of the items 155 initiated by the patron. Identification of the items 155 is compared to the POS database 150, which contains pertinent information about each item 155 (e.g., price) and the patron can view details, advertisements, prices and discounts related to each item 155.

The patron can used various different methods to pay for the items 155. For example, credit card authorizations can be performed using 911 software. The 911 software uses an Internet connection and a load authorization server service running on the processor 133 to deliver an instant approval code and thereafter to deliver batch load transactions to a bank merchant account. The card reader (e.g., magnetic card swipe) 135 is a standard POS, Inc. keyboard wedge and is mounted on the self-checkout kiosk 105 and emulates keyboard entries. The POS software 145 segregates the input and uses it for credit card approvals. The POS software uses any card with a magnetic strip. The receipt printer is a SWECOIN TTP 1020 mounted on the self-checkout kiosk 105. Standard print commands are processed from the POS software 145. In some installations, a second wireless printer may be utilized. Cash transactions are completed with an interfaced bill validator 142, the POS software 145 and a coin changer 141. When the patron selects a currency transaction it may be finalized with the dispensing of change. Charging purchases to a patron's specific location, such as a hotel room, is completed by entry of a room number or other identifying information with a receipt printed on the local printer and on the wireless printer. Cash card purchases are available by utilizing the card reader 135 or biometric interfaces such as a fingerprint reader and associating inserted cash with a store value account.

During the checkout process, the patron has the opportunity, if needed, to request assistance from an employee using a call device 140. For example, the patron can use the touch screen 130 to request live audio and video assistance (i.e., checkout, product or price assistance) from an employee via a SIP (Session Initiated Protocol) telephone call. The employee assisting the patron may be located at the remote call device 170, which is at a remote location from the kiosk 105. The patron may not be able to see or determine where the employee is located but will be able to speak to the employee using the call device 140. The call device 140 and the remote call device 170 establish a communication link that allows bilateral verbal communication between the patron and the employee even though the employee is located a distance away from the kiosk 105.

Additionally, the employee can monitor the state of the distance and direction RFID readers 110, 166, the processor 133, the POS software 145, and the associated components. Furthermore, the employee can reboot any of the components and systems and update and revise the POS software 145. The system 100 may include a 4-port Linksys wireless router, which can be connected to a cable modem or a DSL connection.

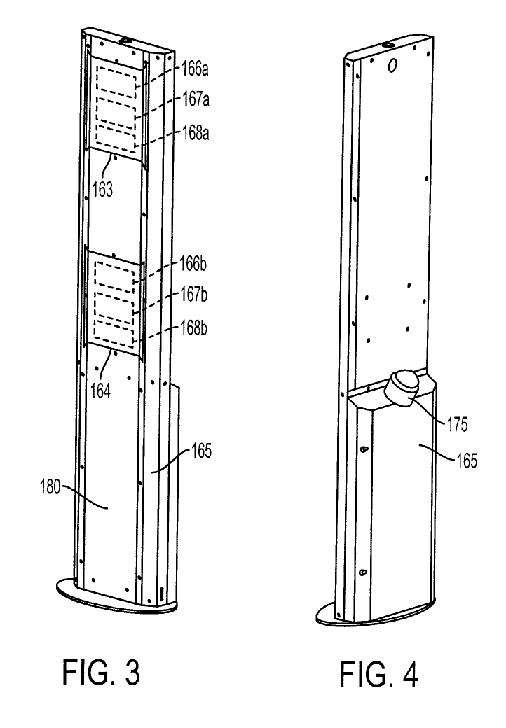

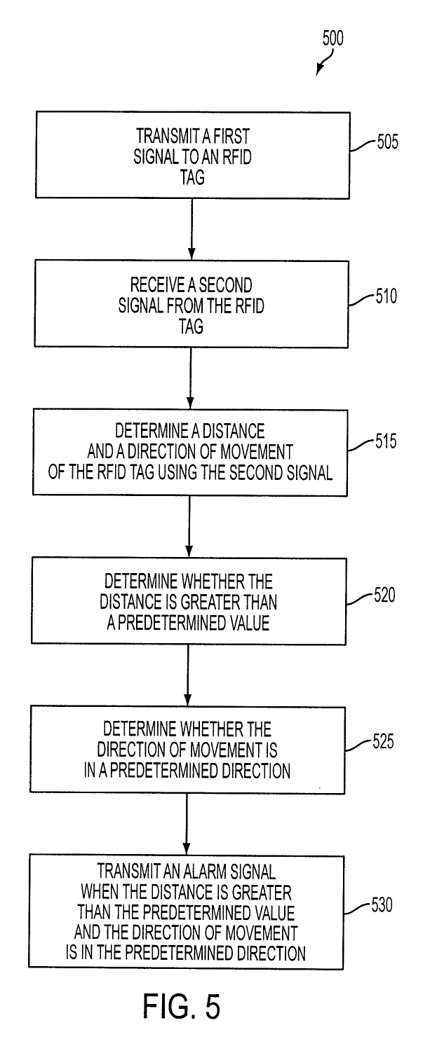

FIGS. 3 and 4 are front and rear perspective views of the security module and gate module of FIG. 1. Referring to FIGS. 3 and 4, the security module and gate module 165 may be a self standing rectangular box that contains one or more RFID antennas 167, 168 (preferably 2 RFID antennas) and an audible alarm 175, which is wirelessly or wire connected to the kiosk 105. The security module and gate module 165 is wirelessly or wire connected to the processor 133. The security module and gate module 165 may include a security gate 180 and may be an armature made of a material that allows passage of RF signals. In one embodiment, the security module and gate module 165 is made out of a metallic material (e.g., steel) with first and second non-metallic (e.g., acrylic) panels or plates 163 and 164 to allow the passage of RF signals at a frequency of about 915 MHz. In one embodiment, first security transmitter 168a and first security receiver 167a are positioned behind the first acrylic panel 163 and second transmitter 168b and second receiver 167b are positioned behind the second acrylic panel 164. A person skilled in the art will appreciate that the kiosk 105 and the security module and gate module 165 may be constructed of various materials including plastic and fiberglass which also allow the passage of RF signals of desired frequencies. One advantage of the security module and gate module 165 is its overall small footprint size.

In one embodiment, the distance and direction RFID reader 166 may include two circularly polarized 915 MHz antennas both mounted in the same or similar direction. In one embodiment, the first antenna may be mounted behind the first acrylic panel 163 of the security module and gate module 165. The second antenna may be mounted adjacent and/or perpendicular to the first antenna such as behind the second acrylic panel 164. The two antennas create strong tag detection coverage by emitting a 45 degree radiation pattern from each antenna which serves the purpose of detecting tagged items 155 or products to detect theft.

Should a patron attempt to exit the location by walking away from the kiosk 105 towards an exit without paying for the items 155, the distance and direction RFID reader 166, which may be controlled using the processor 133 and/or the POS software 145, sends control signals to instruct the security camera 125 to capture an image, record the patron, initiate the audible alarm 175, and record a theft event in the POS database 150 with a time stamp and a date stamp that is associated with the RFID tags 160. A security camera 125 may be located on the kiosk 105 and/or the security module and gate module 165. The system 100 advantageously provides the kiosk 105 with POS software 145, remote management using remote call device 170, the distance and direction RFID readers 110, 166, and the security camera 125 functioning harmoniously for an automatic self-checkout that is theft deterrent.

One advantage of the invention may include a single unit having multiple RFID antennas, POS software and distance and direction RFID readers. Another advantage of the invention may include the detection of an RFID tag's distance and direction to determine if a patron is checking out or exiting the system without paying for the product. Additional advantages of the invention include: (1) the use of a tray and two perpendicular adjacent mounted circular antennas to detect the vended product on the tray combined with the orientation of the antennas; (2) a distance and direction RFID reader in combination with POS software for inventory management and for allowing the shelf stocking duties to be performed at the kiosk; and (3) the ability to integrate security features such as alarm notifications.

Those of ordinary skill would appreciate that the various illustrative logical blocks, modules, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed methods.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A self-checkout kiosk system, comprising:
a main housing having a first acrylic panel;
a first RF antenna positioned adjacent to the first acrylic panel to transmit a TX signal toward an RFID tag;
a second RF antenna positioned adjacent to the first acrylic panel to receive a RX signal from the RFID tag;
a first RFID reader, positioned in the main housing, to determine a distance to the RFID tag using the RX signal;
a remote housing having a second acrylic panel;
a third RF antenna positioned adjacent to the second acrylic panel to transmit a TX signal toward the RFID tag;
a fourth RF antenna positioned adjacent to the second acrylic panel to receive a RX signal from the RFID tag; and
a second RFID reader, positioned in the remote housing, to receive the RX signal from the RFID tag and to determine whether the RFID tag has traveled beyond a certain distance in a certain direction away from the second RFID reader and if so, to transmit a security signal to sound an alarm and to receive a description of an item with the RFID tag.

2. The self-checkout kiosk system of claim 1, further comprising POS software to calculate distance and relative direction of the RFID tag.

3. The self-checkout kiosk system of claim 1, further comprising a call device positioned with the main housing to communicate with a remote call device positioned away from the main housing.

4. The self-checkout kiosk system of claim 1, further comprising a security camera to record a patron upon receipt of the security signal.

5. The self-checkout kiosk system of claim 1, further comprising POS software to determine whether the item has been paid for.

6. A self-checkout apparatus for detecting an RFID tag on an item, comprising:
a housing having an acrylic panel;
a memory module positioned in the housing for storing POS software;
a processor for executing the POS software;
an antenna positioned in the housing for transmitting a TX signal through the acrylic panel of the housing to an RFID tag and for receiving a RX signal from the RFID tag;
an RFID reader, positioned in the housing and controlled by the POS software, for determining an item number for the RFID tag using the RX signal;
a security module positioned in a different location than the housing, the security module having an acrylic panel;
an antenna positioned in the security module for transmitting a TX signal through the acrylic panel of the security module to the RFID tag and for receiving a RX signal from the RFID tag; and
a distance and direction RFID reader positioned in the security module to receive the RX signal from the RFID tag and determine a distance and a direction of movement of the RFID tag.

7. The self-checkout apparatus of claim 6, wherein the distance and direction RFID reader is controlled by the processor.

8. The self-checkout apparatus of claim 6, wherein the distance and direction RFID reader determines whether the distance is greater than a predetermined value and the direction of movement is in a predetermined direction, and if so, transmit a security signal and a description of an item with the RFID tag to the processor.

9. The self-checkout apparatus of claim 8, wherein the predetermined value is about 3 feet and the predetermined direction is outside the store.

10. The self-checkout apparatus of claim 8, further comprising a security gate that is activated upon receipt of the security signal.

11. The self-checkout apparatus of claim 8, further comprising a security camera to record a patron upon receipt of the security signal.

12. The self-checkout apparatus of claim 6, further comprising a call device positioned with the housing to communicate with a remote call device positioned away from the housing.

13. The self-checkout apparatus of claim 6, wherein the POS software determines whether the item has been paid for.

14. A method for detecting whether an item has been paid for or stolen using an RFID tag, comprising:
transmitting a first signal to an RFID tag;
receiving a second signal from the RFID tag;
determining a distance and a direction of movement of the RFID tag using the second signal;
determining whether the distance is greater than a predetermined value;
determining whether the direction of movement is in a predetermined direction; and
transmitting an alarm signal when the distance is greater than the predetermined value and the direction of movement is in the predetermined direction.

15. The method of claim 14, further comprising determining a description of the item when the alarm signal is received.

16. The method of claim 14, wherein the predetermined value is about 3 feet and the predetermined direction is outside the store.

17. The method of claim 14, further comprising activating a security gate upon receipt of the alarm signal.

18. The method of claim 14, further comprising activating a security camera upon receipt of the alarm signal.

19. The method of claim 14, further comprising initiating a call from a call device to a remote call device.

20. The method of claim 14, further comprising determining whether the item has been paid for.
